(19) United States
(12) Patent Application Publication
(10) Pub. No.: US 2026/0233743 A1
(43) Pub. Date: Aug. 13, 2026

(54) LANE CHANGE RECOMMENDATION SYSTEM AND LANE CHANGE RECOMMENDATION METHOD

(71) Applicant: HL Klemove Corp., Incheon (KR)

(72) Inventor: Jaehwan KIM, Incheon (KR)

(73) Assignee: HL Klemove Corp., Incheon (KR)

(21) Appl. No.: 19/225,661

(22) Filed: Jun. 2, 2025

(30) Foreign Application Priority Data
Feb. 12, 2025 (KR) 10-2025-0017917

(51) Int. Cl. B60W 30/18; B60W 30/12; B60W 30/182; B60W 50/14

(52) U.S. Cl. CPC B60W 30/18163; B60W 30/12; B60W 30/182; B60W 50/14; B60W 2050/146; B60W 2520/10; B60W 2554/406; B60W 2554/802

(57) ABSTRACT

A lane change recommendation system according to an embodiment of the present disclosure includes: a first sensor that detects surroundings of an ego vehicle; a second sensor that detects body information of the ego vehicle; a navigation device that provides navigation information; and a controller that provides a lane change recommendation to a driver of the ego vehicle or controls a lane change of the ego vehicle based on information collected from the first sensor, the second sensor, and the navigation device. The controller sets a target lane for the ego vehicle based on the navigation information; and when the ego vehicle is driving in the target lane, determines whether overtaking a front vehicle or avoidance of the target lane is required, and if the overtaking or the avoidance is required, determines whether a lane change to an adjacent lane is strategically required.

### CROSS-REFERENCE TO RELATED APPLICATION

This application claims the benefit of and priority to Korean Patent Application No. 10-2025-0017917 filed on Feb. 12, 2025, the entire disclosures of which are incorporated herein by reference.

### TECHNICAL FIELD

The present disclosure relates to a lane change recommendation system and a lane change recommendation method. More specifically, the present disclosure relates to a lane change recommendation system and a lane change recommendation method capable of performing an optimal lane change according to a situation for an ego vehicle driving along a navigation route.

### BACKGROUND

In a vehicle, a Driver Assistance System provides support to the driver while driving for the driver's convenience. Among these, a lane change function provides driver assistance for safely changing lanes when the vehicle intends to change lanes.

Meanwhile, based on the SAE (Society of Automotive Engineers) defined levels of autonomous driving, Level 1 autonomous driving functions supporting only one of steering and acceleration/deceleration control, and Level 2 autonomous driving functions supporting both simultaneously, are currently applied to various vehicle models regardless of OEM and have become quite popularized.

Particularly, recently, demand for the commercialization of Level 2+ autonomous driving technology is increasing, which significantly improves driving convenience compared to Level 2 functions while the driver still holds responsibility for driving, and supports highway entry/exit, automatic lane changes, and merging lane entry.

Accordingly, in driver assistance functions that assist with vehicle lane changes, there is a need for a lane change recommendation system and a lane change recommendation method that can provide Level 2+ autonomous driving functions, enhancing driver convenience.

### SUMMARY

The present disclosure is to solve the problems of the prior art described above, and an object of the present disclosure is to provide a lane change recommendation system and a lane change recommendation method that perform lane change recommendations and lane change control during vehicle driving along a navigation route, according to the requirements for Level 2+ autonomous driving technology.

However, the technical problems to be achieved by the embodiments of the present disclosure are not limited to the technical problems described above, and other technical problems may exist.

As a technical means for achieving the above technical problem, a lane change recommendation system according to an embodiment comprises: a first sensor configured to detect surroundings of an ego vehicle; a second sensor configured to detect body information of the ego vehicle; a navigation device configured to provide navigation information; and a controller configured to provide a lane change recommendation to a driver of the ego vehicle or control a lane change of the ego vehicle based on information collected from the first sensor, the second sensor, and the navigation device, wherein the controller is configured to: set a target lane for the ego vehicle based on the navigation information; and when the ego vehicle is driving in the target lane, determine whether overtaking a front vehicle or avoidance of the target lane is required, and if the overtaking or the avoidance is required, determine whether a lane change to an adjacent lane is strategically required to provide the lane change recommendation or control the lane change.

Further, the controller may comprise: a front vehicle overtaking determiner configured to determine whether overtaking the front vehicle is required when the ego vehicle is driving in the target lane; a lane avoidance determiner configured to determine whether avoidance of the driving lane is required; and a strategic lane change determiner configured to determine whether the lane change to the adjacent lane is strategically required based on the determination of the front vehicle overtaking determiner or the lane avoidance determiner.

Further, the front vehicle overtaking determiner may be configured to determine that overtaking the front vehicle is required when the ego vehicle cannot drive at a set speed due to the front vehicle, and if it is satisfied a predetermined driving situation condition that the ego vehicle does not hinder a traffic flow of surrounding vehicles.

Further, the lane avoidance determiner may comprise a congestion section determiner, a construction section determiner, and a merging section determiner, and the lane avoidance determiner may be configured to determine that avoidance of the driving lane is required when an adjacent lane to the driving lane where the ego vehicle is driving is a congestion section, a construction section, or a merging section.

Further, the controller may comprise a target lane change determiner configured to determine whether changing the target lane of the ego vehicle is required, and if the strategic lane change determiner determined that the lane change is strategically required and the ego vehicle changed lanes accordingly, the target lane change determiner may be configured to change the target lane to the changed lane.

Further, the controller may further comprise a navigation route target lane determiner configured to determine the target lane based on the navigation route, and the target lane change determiner may be configured to change the target lane to an updated route-based target lane when the target lane based on the navigation route has been changed due to an update of the navigation route.

Further, the target lane change determiner may be configured to change the target lane to a current driving lane of the ego vehicle when the ego vehicle is not driving in the target lane, and either the ego vehicle have changed lanes in an opposite direction to the target lane by the driver's input, or a lane change to the target lane has been cancelled by the driver.

Further, if the strategic lane change determiner determined that the strategic lane change is required and the ego vehicle changed lanes accordingly, and if it is determined that the ego vehicle is driving in a passing lane, the target lane change determiner may be configured to change the target lane to a previous driving lane for returning to the previous driving lane.

Further, the controller may comprise a lane recommendation mode determiner configured to determine a recommendation mode from among a route-based lane recommendation mode, a strategic lane recommendation mode, and a driving lane return recommendation mode, based on a driving scenario of the ego vehicle.

Further, the controller may be configured to control the ego vehicle to automatically perform the lane change if a lane change cancellation command from the driver is not received within a predetermined time after providing the lane change recommendation to the driver.

A lane change recommendation method according to an embodiment of the present disclosure comprises: performing a route-based lane recommendation based on a target lane according to a navigation route; determining whether the ego vehicle is driving in the target lane; when the ego vehicle is driving in the target lane, determining whether a strategic lane change is required; and if the strategic lane change is required, performing a lane change recommendation to change lanes to an adjacent lane of a driving lane of the ego vehicle.

The method may further comprise: when the ego vehicle changed lanes according to the performing of the lane change recommendation, changing the changed lane to a new target lane; determining whether the ego vehicle is driving in a passing lane after the target lane change; and if driving in the passing lane, performing a driving lane return recommendation to return to a previous driving lane.

Further, the determining of whether the strategic lane change is required may comprise determining that the strategic lane change is required if it is determined that overtaking a front vehicle is required based on a relationship between the ego vehicle and the front vehicle.

Further, the determining of whether the strategic lane change is required may comprise determining that the strategic lane change is required if it is determined that avoidance of the driving lane is required.

Further, it may be determined that avoidance of the driving lane is required in case that an adjacent lane to the driving lane where the ego vehicle is driving is a congestion section, a construction section, or a merging section.

Further, if the adjacent lane is a congestion section, a construction section, or a merging section, the performing of the lane change recommendation may comprise recommending a lane change to a lane on an opposite side of said adjacent lane.

Further, if it is determined that the ego vehicle is not driving in the target lane in the determining of whether the ego vehicle is driving in the target lane, if a lane change has been performed in an opposite direction of the target lane by a driver's input or a lane change to the target lane has been cancelled by the driver, the lane where the ego vehicle is currently driving may be set as a new target lane.

The method may further comprise performing a route-based lane recommendation based on an updated route-based target lane if the target lane based on the navigation route has been changed due to an update of the navigation route.

The method may further comprise controlling the ego vehicle to automatically perform the lane change if a lane change cancellation command from a driver of the ego vehicle is not received within a predetermined time after performing the lane change recommendation.

Meanwhile, in a non-transitory computer-readable recording medium that records a program for executing a lane change recommendation method according to an embodiment of the present disclosure, the method comprises: performing a route-based lane recommendation based on a target lane according to a navigation route; determining whether the ego vehicle is driving in the target lane; when the ego vehicle is driving in the target lane, determining whether a strategic lane change is required; and if the strategic lane change is required, performing a lane change recommendation to change lanes to an adjacent lane of a driving lane of the ego vehicle.

The above-described means for solving the problem is only exemplary and should not be construed as limiting the present disclosure. In addition to the exemplary embodiments described above, additional embodiments may exist in the drawings and the following detailed description.

According to the problem-solving means described above, the function of the lane change recommendation system essential for Level 2+ autonomous driving functions can be improved, thereby providing a lane change recommendation system and a lane change recommendation method that greatly enhance the driver's driving convenience.

Further, according to the present disclosure, by faithfully implementing the Navigation Route Following (NRF) function according to the navigation route, it is possible to provide a lane change recommendation system and a lane change recommendation method that can promote the driver's driving efficiency and convenience.

However, the effects obtainable from the present disclosure are not limited to the effects described above, and other effects may exist.

### BRIEF DESCRIPTION OF THE DRAWINGS

FIG. 1 is a schematic control configuration diagram of a lane change recommendation system according to an embodiment of the present disclosure.

FIG. 2 is a control configuration diagram showing in more detail the configuration of the controller in the lane change recommendation system according to the embodiment of the present disclosure.

FIG. 3 is a diagram showing a driving scenario according to a route-based lane recommendation mode in the lane change recommendation system according to the embodiment of the present disclosure.

FIG. 4 is a diagram showing a driving scenario according to a strategic lane change recommendation mode in the lane change recommendation system according to the embodiment of the present disclosure.

FIG. 5 is a diagram showing a driving scenario according to a driving lane return recommendation mode in the lane change recommendation system according to the embodiment of the present disclosure.

FIG. 6 is a schematic control flowchart showing a lane change recommendation method according to an embodiment of the present disclosure.

FIG. 7 is a schematic control flowchart showing a control flow for lane change recommendation when the ego vehicle is not driving in the target lane in the lane change recommendation method according to the embodiment of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a lane change recommendation system and a lane change recommendation method capable of performing an optimal lane change according to the situation for an ego vehicle driving along a navigation route.

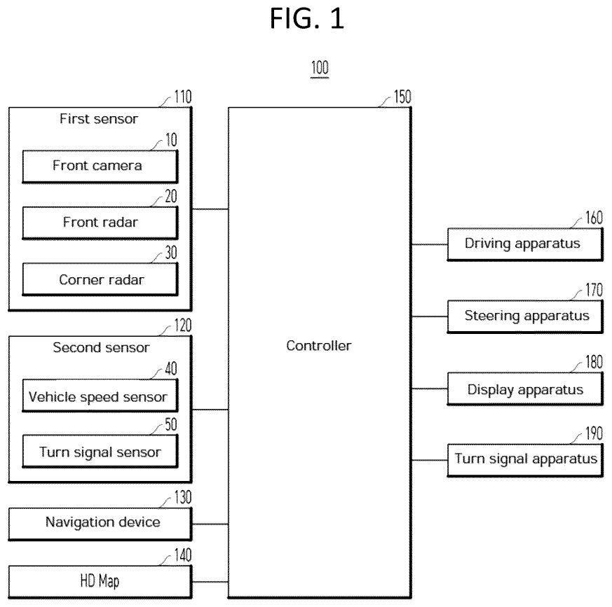

FIG. 1 is a schematic control configuration diagram of a lane change recommendation system according to an embodiment of the present disclosure.

First, referring to FIG. 1, the lane change recommendation system 100 according to an embodiment of the present disclosure may comprise a first sensor 110 configured to detect surroundings of an ego vehicle, a second sensor 120 configured to detect body information of the ego vehicle, and a navigation device 130 configured to provide navigation information.

Further, the lane change recommendation system 100 according to the embodiment of the present disclosure may comprise a controller 150 configured to provide a lane change recommendation to a driver of the ego vehicle or control the lane change of the ego vehicle based on information collected from the first sensor 110, the second sensor 120 and the navigation device 130.

Further, the controller 150 may set a target lane for the ego vehicle based on the navigation information. When the ego vehicle is driving in the target lane, if overtaking a front vehicle is required or avoidance of the target lane is required, the controller may determine whether a strategic lane change to an adjacent lane is required and provide a lane change recommendation or control the lane change.

The first sensor 110 may include at least one of a front camera 10, a front radar 20, or a corner radar 30. However, the sensors included in the first sensor 110 are not limited thereto and may include other types of sensors for detecting the surroundings of the vehicle, such as lidar sensors, ultrasonic sensors, etc.

The second sensor 120 may include at least one of a vehicle speed sensor 40 or a turn signal sensor 50. However, the configuration of the second sensor 120 is not limited thereto, and may include other types of sensors for detecting the body information of the ego vehicle, such as a steering angle sensor, a steering torque sensor, etc.

The navigation device 130 may include a GPS sensor for detecting the position of the ego vehicle and a navigation map providing surrounding map information, and may generate a driving route (navigation route) of the ego vehicle based on the driver's input of the destination.

Further, the lane change recommendation system 100 according to the embodiment of the present disclosure may comprise an HD Map 140. The HD Map 140 may refer to a high-definition map and may provide position information of the ego vehicle and map information at the location where the ego vehicle is driving.

Further, the lane change recommendation system 100 according to the embodiment of the present disclosure may comprise a driving apparatus 160 configured to control the longitudinal driving of the ego vehicle and a steering apparatus 170 configured to control the lateral driving of the ego vehicle. Accordingly, when controlling the lane change of the ego vehicle by the controller 150, the controller 150 may control the driving apparatus 160 or the steering apparatus 170 to control the ego vehicle to change lanes to an adjacent lane.

Further, the lane change recommendation system 100 according to the embodiment of the present disclosure may comprise a display apparatus 180. For example, the display apparatus may be an HMI (Human Machine Interface). Accordingly, the controller 150 may provide a lane change recommendation to the driver by displaying the recommended lane change direction on the display apparatus 180, or provide information to the driver by displaying that an automatic lane change is in progress on the display apparatus 180 during the automatic lane change performed by the controller 150.

Further, the lane change recommendation system 100 according to the embodiment of the present disclosure may comprise a turn signal apparatus 190 configured to operate the turn signal of the ego vehicle. For example, the controller 150 may operate the turn signal apparatus 190 during the lane change recommendation or the automatic lane change.

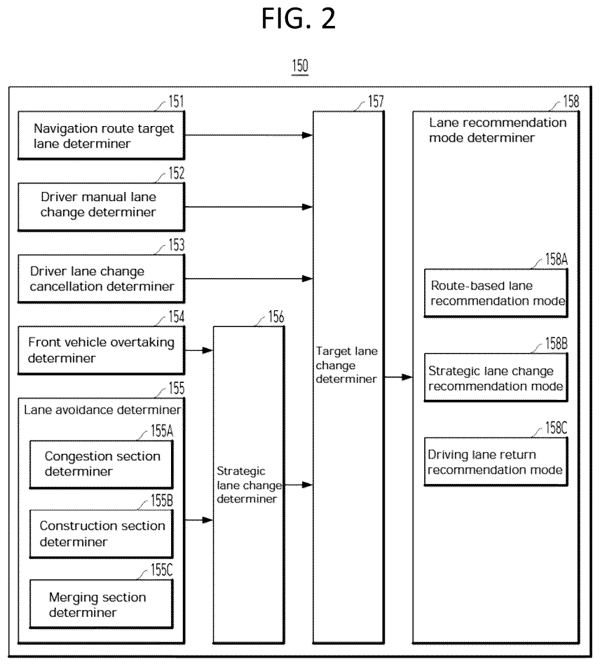

Referring to FIG. 2, the configuration of the controller 150 according to the embodiment of the present disclosure will be explained in more detail. FIG. 2 is a control configuration diagram showing in more detail the configuration of the controller in the lane change recommendation system according to the embodiment of the present disclosure.

Referring to FIG. 2, the controller 150 according to the embodiment of the present disclosure may comprise a navigation route target lane determiner 151. The navigation route target lane determiner 151 may determine the target lane where the ego vehicle needs to drive based on the navigation route provided from the navigation device 130.

Further, when the ego vehicle is driving in the set target lane, the controller 150 may comprise a front vehicle overtaking determiner 154 for determining whether overtaking a front vehicle is required, and a lane avoidance determiner 155 for determining whether avoidance of the driving lane is required.

Further, the controller 150 may comprise a strategic lane change determiner 156 for determining whether a strategic lane change to an adjacent lane is required based on the determination of the front vehicle overtaking determiner 154 or the lane avoidance determiner 155.

The front vehicle overtaking determiner 154, when the ego vehicle cannot drive at the set speed due to the front vehicle, may determine overtaking of the front vehicle is required if a predetermined driving situation condition of not hindering the traffic flow of surrounding vehicles is satisfied.

Specifically, the front vehicle overtaking determiner 154 may determine whether the ego vehicle is driving at the set speed by using the difference between the set speed of the ego vehicle and the actual driving speed. If the ego vehicle cannot drive at the set speed, it may determine whether part of the conditions for overtaking is satisfied by using at least one of the relative speed between the ego vehicle and the front vehicle in the driving lane, the vehicle type of the front vehicle, the inter-vehicle distance between the ego vehicle and the front vehicle, the relative distance between the ego vehicle and the front-side vehicle of the target lane, or the relative distance between the ego vehicle and the rear-side vehicle of the target lane. Whether these conditions regarding the relationship between the ego vehicle, the driving lane, and surrounding vehicles of the target lane are satisfied may be determined, for example, using an SVM (Support Vector Machine) model trained to classify data from situations where lane changes are made versus situations where they are not.

Additionally, the front vehicle overtaking determiner 154 may calculate the acceleration gain value between the ego vehicle, the driving lane, and surrounding vehicles of the target lane, and finally determine whether overtaking the front vehicle is required based on whether the calculated acceleration gain value is greater than or equal to a predetermined threshold value. Here, the acceleration gain value may be calculated using, for example, a predetermined MOBIL (Minimizing Overall Braking Induced by Lane Changes) algorithm.

Accordingly, if the front vehicle overtaking determiner 154 determines that overtaking the front vehicle is required and a lane change to the adjacent lane is possible, the strategic lane change determiner 156 may determine that a strategic lane change is required.

Further, the lane avoidance determiner 155 may comprise a congestion section determiner 155A for determining if the adjacent lane is a congestion section, a construction section determiner 155B for determining if the adjacent lane is a construction section, and a merging section determiner 155C for determining if the adjacent lane is a merging section.

If the adjacent lane to the driving lane (target lane) is a congestion section, construction section, or merging section, the lane avoidance determiner 155, may determine that avoidance of the driving lane is required. This is because if the adjacent lane is a congestion section, construction section, or merging section, continuing to drive in the current target lane is more efficient in terms of driving speed or driving risk.

Whether the adjacent lane is a congestion section may be determined by collecting the road information where the ego vehicle is driving and information on surrounding vehicles driving in the adjacent lane, and determining the congestion level based on a traffic flow model. For example, slots may be assigned to surrounding vehicles aligned in the adjacent lane, and the tendency of the driving speed of the adjacent lane may be confirmed by determining whether slot maintenance conditions or slot transition conditions are satisfied, thereby determining the congestion level of the adjacent lane.

Further, whether the adjacent lane is a construction section may be determined by recognizing traffic cones or rubber cones using a front camera installed at the ego vehicle. Further, whether the adjacent lane is a merging section may be determined from map information of the navigation device or map information of the HD Map.

Further, the controller 150 may comprise a target lane change determiner 157 for determining whether the target lane needs to be changed. If the strategic lane change determiner 156 determined that a strategic lane change is required and the ego vehicle changed lanes to the adjacent lane, the target lane change determiner 157 may change the target lane to the changed lane (driving lane of the ego vehicle). That is, if a lane change recommendation is made based on the determination of the strategic lane change determiner 156, the target lane change determiner 157 may reset (change) the driving lane of the ego vehicle after the strategic lane change as the target lane.

Further, the target lane change determiner 157 may determine that the target lane change is required, when the target lane according to the navigation route is changed through the navigation route target lane determiner 151 in case that the navigation route is newly updated in the navigation device 130. That is, the target lane change determiner 157 may reset the target lane to a route-based target lane which is newly updated based on the navigation route.

Further, when the ego vehicle is not driving in the target lane, and the driver changed lanes in the opposite direction of the target lane by the driver's input, or the driver cancelled the lane change to the target lane, the target lane change determiner 157 may change the lane where the ego vehicle is driving to a new target lane.

For example, the case that the driver changed lanes in the opposite direction of the target lane by the driver's input may occur when the system recommended a lane change to the left lane according to the target lane, but the driver performed a lane change (steering wheel operation) to the right lane, which is the opposite direction. According to the embodiment of the present disclosure, through the driver manual lane change determiner 152 shown in FIG. 2, it may be determined whether the driver performed a lane change by operating the steering wheel. If the driver performed the lane change in the opposite direction, the lane currently being driven in after the lane change may be changed to a new target lane.

Further, the case that the driver cancelled the lane change to the target lane may occur when the system recommended a lane change to the left lane according to the target lane, but the driver operated the right turn signal. According to the embodiment of the present disclosure, through the driver lane change cancellation determiner 153 shown in FIG. 2, it may be determined whether the driver cancelled the lane change by operating the turn signal in the opposite direction. If the driver cancelled the lane change, the currently driven lane may be changed to the new target lane.

As such, if the lane is changed to the opposite direction of the target lane by the driver's input or the lane change to the target lane is cancelled by the driver, the driver's intention is not to change lanes to the target lane. Therefore, the driving lane of the ego vehicle (the driving lane moved in the opposite direction or the existing driving lane) may be set as the target lane to follow the driver's intention.

Further, when the strategic lane change determiner 156 determines that a strategic lane change is required and the ego vehicle changes lanes accordingly, and if it is determined that the ego vehicle is driving in a passing lane, the target lane change determiner 157 may reset the target lane to the previous driving lane to return to the previous driving lane.

This is because, for example, if a lane change was performed because overtaking the front vehicle was determined to be required (or lane avoidance was required), and the changed lane is a passing lane (Passing Lane or Overtaking Lane), continuous driving in the passing lane is not allowed according to traffic regulations. Therefore, it is necessary to recommend returning to the previous driving lane (traffic lane under traffic regulations).

Meanwhile, the case of recommending a return to the driving lane is not limited to the scenario described above. For example, even if the lane change recommendation system is activated while the ego vehicle is already driving in a passing lane, a lane change to a driving lane other than the passing lane may be recommended.

Further, referring to FIG. 2, the controller 150 may comprise a lane recommendation mode determiner 158 that determines one recommendation mode among a route-based lane recommendation mode 158A, a strategic lane recommendation mode 158B, and a driving lane return recommendation mode 158C, based on the driving scenario of the ego vehicle.

In relation to mode setting according to driving scenario, even in case that the target lane is changed by the driver's manual lane change, lane change cancellation, or by return recommendation, if a new target lane is generated by updating the navigation route while the vehicle is driving, the target lane change determiner 157 may reset the new target lane.

For example, if the target lane according to the navigation route is initially lane 2, and the vehicle is driving in lane 4, the lane recommendation system may continuously recommend changing lanes to lane 2. At this time, if the lane 4 is set as the target lane due to the driver's driving in the opposite direction or lane change cancellation, and the target lane according to the navigation route is changed to lane 5 due to the update of the navigation route while the vehicle is driving in the lane 4, the target lane may be changed to the lane 5 and a lane change recommendation may be made from that time.

That is, according to the lane change recommendation system according to the embodiment of the present disclosure, while driving the ego vehicle, based on the driving scenario, it is possible to determine the lane recommendation mode in real time by continuously determining whether to make lane recommendation according to the navigation route, make strategic lane change recommendation, or make lane return recommendation when driving in the passing lane.

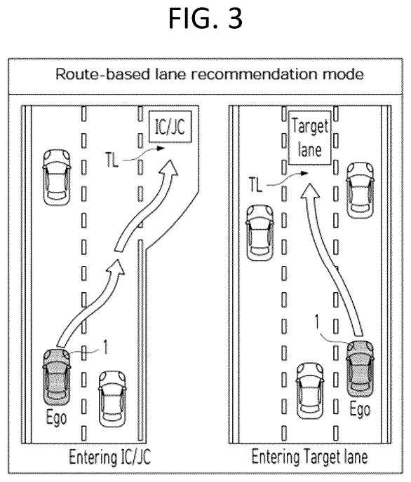

Regarding each lane recommendation mode (the route-based lane recommendation mode 158A, the strategic lane recommendation mode 158B, and the driving lane return recommendation mode 158C), a more detailed description will be provided through the explanations of FIGS. 3 to 5.

Meanwhile, after recommending a lane change to the driver, the controller 150 may control the ego vehicle to automatically perform the lane change if a lane change cancellation command from the driver is not received within a predetermined time (e.g., approximately 1 second).

For example, the lane change recommendation system 100 may recommend a lane change to the driver. If the driver does not wish to change lanes after receiving the recommendation, the driver may cancel the lane change through actions like operating a lane change cancellation button or operating the turn signal in the opposite direction. Meanwhile, if the driver wishes to change lanes, the controller 150 may automatically control the ego vehicle to perform the lane change without requiring separate input after a predetermined time elapses. The predetermined time here may be, for example, approximately 1 second, but is not limited thereto.

Meanwhile, the present disclosure is not limited to the control described above. For example, the system may recommend a lane change, and only perform the automatic lane change if the driver confirms the recommendation. Here, the driver's confirmation may involve actions such as the driver rotating the steering wheel in the recommended lane change direction, or the driver operating the turn signal in the recommended lane change direction.

According to the embodiment described above, driving convenience compared to existing Level 2 functions can be significantly improved, while the driver retains responsibility for driving, thereby providing a lane change recommendation system capable of realizing Level 2+ autonomous driving technology that supports highway entry/exit, automatic lane changes, merging lane entry, etc.

Further, according to the lane change recommendation system of the embodiment of the present disclosure, the Navigation Route Following (NRF) function according to the navigation route can be faithfully implemented, while also promoting the driver's driving efficiency and convenience.

Hereinafter, the route-based lane recommendation mode, the strategic lane change recommendation mode, and the driving lane return recommendation mode will be described in detail with reference to FIGS. 3 to 5.

FIG. 3 is a diagram showing a driving scenario according to a route-based lane recommendation mode in the lane change recommendation system according to the embodiment of the present disclosure.

Referring to FIG. 3, in the lane change recommendation system according to the embodiment of the present disclosure, based on the route-based lane recommendation mode, a target lane TL based on the navigation route may be set.

The left diagram of FIG. 3 illustrates such a target lane based on the navigation route being, for example, at a highway exit/entry, i.e., an IC (Interchange)/JC (Junction). If driving towards the exit lane is required according to the navigation route at the IC/JC etc., the corresponding exit lane (the rightmost lane) may be the target lane TL.

In this case, the lane change recommendation system according to the embodiment may recommend a lane change such that the ego vehicle 1 moves to the target lane TL based on the navigation route, as shown in the left diagram of FIG. 3.

Further, for example, as shown in the right diagram of FIG. 3, when driving on a highway not in an IC/JC situation, the target lane TL based on the navigation route may be a middle lane. In this case, the lane change recommendation system according to the embodiment may recommend a lane change so that the ego vehicle 1 changes lanes to the target lane TL based on the navigation route, as shown in the right diagram of FIG. 3.

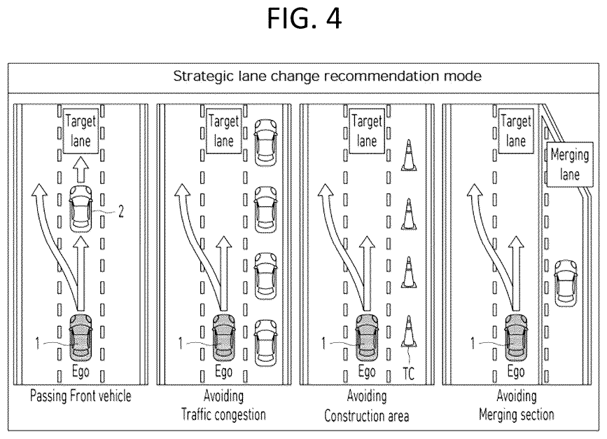

FIG. 4 is a diagram showing a driving scenario according to a strategic lane change recommendation mode in the lane change recommendation system according to the embodiment of the present disclosure.

The first diagram in FIG. 4 shows a case where overtaking the front vehicle 2 is recommended strategically. For example, when the ego vehicle 1 is driving in the target lane based on the navigation route, if the ego vehicle cannot drive at the set speed due to the front vehicle 2, and if the conditions for overtaking the front vehicle, as described previously, are satisfied, a lane change to the adjacent lane may be recommended according to the strategic lane change recommendation mode.

The second diagram in FIG. 4 shows a case where a lane change is strategically recommended when the adjacent lane is a congested area. For example, when the ego vehicle 1 is driving in a target lane based on a navigation route, the road information where the ego vehicle is driving and the information on surrounding vehicles driving in the adjacent lane are collected, and the congestion level may be determined based on a traffic flow model, thereby confirming whether there is congestion in the adjacent lane.

If the adjacent lane is a congested section, there might be vehicles entering the driving lane of the ego vehicle 1 from the adjacent lane, posing a collision risk and making it difficult to increase speed of the ego vehicle. Therefore, continuing to drive in the current target lane may not be efficient. Accordingly, as shown in the diagram, a lane change to an adjacent lane on the opposite side of the congested adjacent lane may be strategically recommended.

The third diagram in FIG. 4 shows a case where a lane change is strategically recommended when the adjacent lane is a construction area. For example, when the ego vehicle 1 is driving in the target lane based on the navigation route, if traffic cones TC are recognized using the front camera installed at the ego vehicle 1, determining that the adjacent lane is a construction section.

If the adjacent lane is a construction section, continuing to drive in the target lane may not be efficient in terms of driving risk or driving speed. Therefore, as shown in the diagram, a lane change to an adjacent lane on the opposite side of the adjacent lane which is a construction section may be strategically recommended.

The fourth diagram in FIG. 4 shows a case where a lane change is strategically recommended if the adjacent lane is a merging road (merging section). For example, when the ego vehicle 1 is driving in the target lane based on the navigation route, if it is determined from map information of the navigation device or map information of the HD Map that the adjacent lane is a merging section.

If the adjacent lane is a merging section, vehicles entering the target lane from the merging section may exist, posing a collision risk and making continuous driving in the target lane potentially inefficient. Therefore, as shown in the diagram, a lane change to an adjacent lane on the opposite side of the adjacent lane which is the merging section may be strategically recommended.

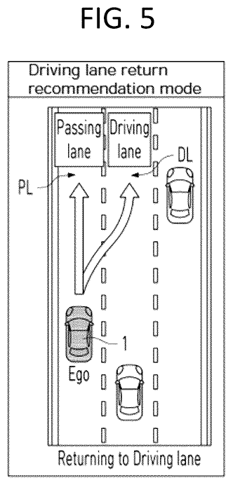

FIG. 5 is a diagram showing a driving scenario according to a driving lane return recommendation mode in the lane change recommendation system according to the embodiment of the present disclosure.

Referring to FIG. 5, for example, if a lane change was performed due to the need to overtake the front vehicle or avoid the lane according to the strategic lane change recommendation as in FIG. 4, the ego vehicle 1 may be driving in the passing lane PL. Meanwhile, continuous driving in the passing lane PL is not desirable according to traffic regulations. Therefore, a lane change recommendation to return to the previous driving lane DL may be made.

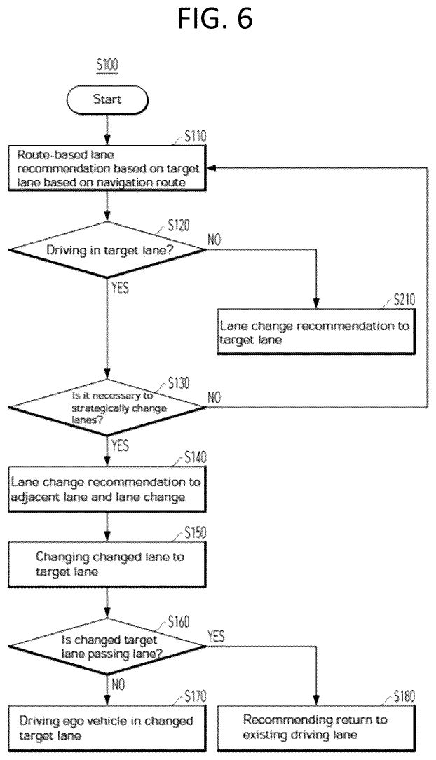

FIG. 6 is a schematic control flowchart showing a lane change recommendation method according to an embodiment of the present disclosure.

Referring to FIG. 6, the lane change recommendation method S100 according to an embodiment of the present disclosure may comprise performing a route-based lane recommendation based on a target lane according to a navigation route S110.

Information on the target lane according to the navigation route may be acquired from the navigation device, and based on this target lane according to the navigation route, a route-based lane recommendation may be performed.

Subsequently, determining whether the ego vehicle is driving in the target lane S120 may be performed.

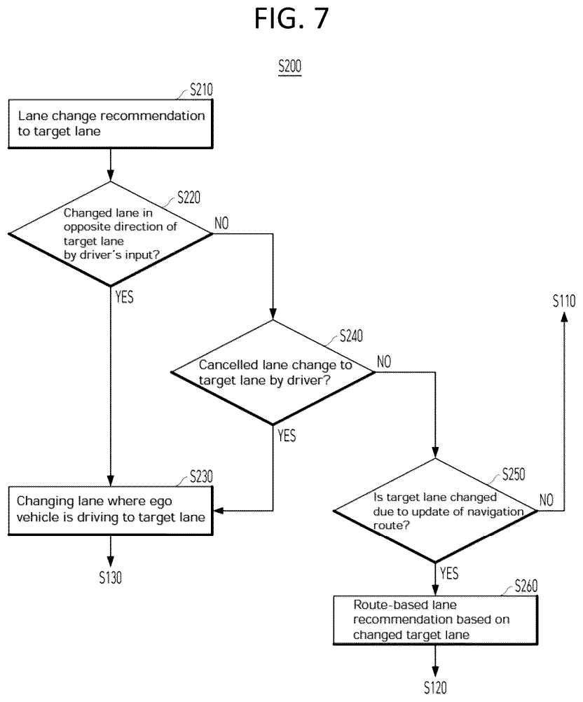

If the ego vehicle is not driving in the target lane (‘NO’ in S120), a lane change recommendation to drive towards the target lane S210 may be performed, and if the ego vehicle is driving in the target lane (‘YES’ in S120), determining whether a strategic lane change is required S130 may be performed. Meanwhile, the specific control flow for lane change recommendation to the target lane S200 when the ego vehicle is not driving in the target lane will be described in detail with reference to FIG. 7.

In determining whether a strategic lane change is required S130, if it is determined that a strategic lane change is required (‘YES’ in S130), recommending a lane change to an adjacent lane of the driving lane of the ego vehicle S140 may be performed.

In addition, the determining of whether a strategic lane change is required S130 may determine that a strategic lane change is required if it is determined that the ego vehicle needs to overtake the front vehicle in the relationship between the ego vehicle and the front vehicle. Specifically, in case that the ego vehicle cannot drive at the set speed due to the front vehicle, it may be determined that overtaking the front vehicle is required if it is satisfied certain driving conditions that the ego vehicle does not hinder the traffic flow of surrounding vehicles.

As previously discussed, if the ego vehicle cannot drive at the set speed, it may determine whether part of the conditions for overtaking is satisfied by using at least one of the relative speed between the ego vehicle and the front vehicle in the driving lane, the vehicle type of the front vehicle, the inter-vehicle distance between the ego vehicle and the front vehicle, the relative distance between the ego vehicle and the front-side vehicle of the target lane, or the relative distance between the ego vehicle and the rear-side vehicle of the target lane. Whether these conditions regarding the relationship between the ego vehicle, the driving lane, and surrounding vehicles of the target lane are satisfied may be determined, for example, using an SVM (Support Vector Machine) model trained to classify data from situations where lane changes are made versus situations where they are not.

Additionally, the front vehicle overtaking determiner 154 may calculate the acceleration gain value between the ego vehicle, the driving lane, and surrounding vehicles of the target lane, and finally determine whether overtaking the front vehicle is required based on whether the calculated acceleration gain value is greater than or equal to a predetermined threshold value. Here, the acceleration gain value may be calculated using, for example, a predetermined MOBIL (Minimizing Overall Braking Induced by Lane Changes) algorithm.

In addition, determining whether the strategic lane change is required S130 may determine that the strategic lane change is required if it is determined that it is necessary to drive with avoiding the driving lane.

Meanwhile, cases where it is determined to be required to drive with avoiding the driving lane may include cases where the adjacent lane to the driving lane of the ego vehicle is a congested section (when vehicles in the adjacent lane are congested), the adjacent lane is a construction section (when the adjacent lane is an area under construction), or the adjacent lane is a merging section (where the adjacent lane merges with the driving lane).

As previously discussed, if the adjacent lane to the driving lane of the vehicle is a congested section, a construction section, or a merging section, since it is more efficient to drive by avoiding the driving lane even if the driving lane is the target lane, it may be said that it is a case where a strategic lane change is required.

Accordingly, according to the embodiment of the present disclosure, if the adjacent lane is a congested section, if the adjacent lane is a construction section, or if the adjacent lane is a merging section, a lane change recommendation may be made to change lanes to an adjacent lane on the opposite side of the adjacent lane.

Further, if the ego vehicle changed lanes according to the lane change recommendation step S140, changing (resetting) the changed lane to a new target lane S150 may be performed. This is to follow the strategic lane recommendation mode rather than following the target lane according to the navigation route when a strategic lane change is required.

Further, after the target lane change, determining whether the ego vehicle is driving in a passing lane S160 may be performed. Determining whether driving in a passing lane may be performed because continuous driving in the passing lane is undesirable according to traffic regulations.

Meanwhile, if the ego vehicle is not driving in the passing lane (‘NO’ in S160), the ego vehicle may continue to drive in the changed target lane according to the strategic lane change recommendation (S170). If the ego vehicle is driving in the passing lane (‘YES’ in S160), a lane return recommendation to return to the previous driving lane S180 may be performed.

FIG. 7 is a schematic control flowchart showing a control flow for lane change recommendation when the ego vehicle is not driving in the target lane in the lane change recommendation method according to the embodiment of the present disclosure.

Referring to FIG. 7, if it is determined that the ego vehicle is not driving in the route-based target lane, performing a lane change recommendation to the target lane S210 may be performed.

Subsequently, determining whether the driver changed lanes in the opposite direction of the target lane by the driver's input S220 despite the lane change recommendation, may be performed. For example, if a recommendation was made to change to the left lane according to the target lane, but the driver performed a lane change (steering wheel operation) to the right lane, which is the opposite direction.

If the driver changed lanes in the opposite direction of the target lane by the driver's input (‘YES’ in S220), the lane where the ego vehicle is driving (i.e., the lane after the opposite direction lane change) may be changed (set) to the target lane (S230).

Meanwhile, if the driver did not change lanes in the opposite direction of the target lane by the driver's input (‘NO’ in S220), determining whether the driver cancelled the lane change to the target lane S240 may be performed. For example, it may be the case that a recommendation was made to change to the left lane according to the target lane, but the driver operated the right turn signal.

If the driver cancelled the lane change to the target lane (‘YES’ in S240), since the ego vehicle continues to drive in the current lane, the currently driven lane may be changed (set) to the target lane (S230).

Meanwhile, when the route-based target lane changed due to an update of the navigation route, route-based lane recommendation may be made based on the changed route-based target lane.

Referring to FIG. 7, if the driver did not change lanes in the opposite direction of the target lane (‘NO’ in S220), and the driver did not cancel the lane change to the target lane (‘NO’ in S240), it may be determined whether the route-based target lane was changed due to an update of the navigation route (S250). If the route-based target lane was changed (‘YES’ in S250), a route-based lane recommendation based on the changed target lane S260 may be performed.

Meanwhile, FIG. 7 illustrates the case where the route-based target lane according to navigation route update was changed when the driver did not change lanes opposite to the target lane or did not cancel the lane change to the target lane. However, even after the target lane has been changed since the driver changed lanes opposite to the target lane or the driver cancelled the lane change (i.e., after the step S230), if the navigation route is updated, a route-based lane recommendation based on the newly changed route-based target lane may be performed.

Further, according to the lane change recommendation method of the embodiment of the present disclosure, after recommending a lane change to the driver, if a lane change cancellation command from the driver is not received within a predetermined time (e.g., approximately 1 second), the ego vehicle may be controlled to automatically perform the lane change.

According to the embodiments of the present disclosure described above, based on the route-based lane recommendation, lane changes are recommended. Further, according to the embodiments of the present disclosure, during driving, it is continuously determined whether a strategic lane change is required or, whether there is the driver's intention or whether there is a need for returning to the previous lane if driving in a passing lane, and the target lane may be changed in real-time to perform lane recommendation based on the determination. Therefore, it is possible to achieve effective driving control for implementing Level 2+ autonomous driving.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the above-described embodiments of the present disclosure, it is possible to provide a lane change recommendation system and a lane change recommendation method for faithfully implementing the Navigation Route Following (NRF) function according to the navigation route, thereby promoting the driver's driving efficiency and driving stability.

In addition, according to the lane change recommendation system and the lane change recommendation method according to the embodiments of the present disclosure, a lane recommendation system essential to the Level 2+ autonomous driving function can be further improved, thereby providing an autonomous driving function that significantly improves the driver's driving convenience compared to the existing Level 2 function.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: Front vehicle
100: Lane change recommendation system
110: First sensor
120: Second sensor
130: Navigation device
140: HD Map
150: Controller
151: Navigation route target lane determiner
152: Driver manual lane change determiner
153: Driver lane change cancellation determiner
154: Front vehicle overtaking determiner
155: Lane avoidance determiner
156: Strategic lane change determiner
157: Target lane change determiner
158: Lane recommendation mode determiner
160: Driving apparatus
170: Steering apparatus
180: Display apparatus
190: Turn signal apparatus

What is claimed is:

1. A lane change recommendation system, comprising:
a first sensor configured to detect surroundings of an ego vehicle;
a second sensor configured to detect body information of the ego vehicle;
a navigation device configured to provide navigation information; and
a controller configured to provide a lane change recommendation to a driver of the ego vehicle or control a lane change of the ego vehicle based on information collected from the first sensor, the second sensor, and the navigation device,
wherein the controller is configured to:
set a target lane for the ego vehicle based on the navigation information; and
when the ego vehicle is driving in the target lane, determine whether overtaking a front vehicle or avoidance of the target lane is required, and if the overtaking or the avoidance is required, determine whether a lane change to an adjacent lane is strategically required to provide the lane change recommendation or control the lane change.

2. The system of claim 1, wherein the controller comprises:
a front vehicle overtaking determiner configured to determine whether overtaking the front vehicle is required when the ego vehicle is driving in the target lane;
a lane avoidance determiner configured to determine whether avoidance of the driving lane is required; and
a strategic lane change determiner configured to determine whether the lane change to the adjacent lane is strategically required based on the determination of the front vehicle overtaking determiner or the lane avoidance determiner.

3. The system of claim 2, wherein the front vehicle overtaking determiner is configured to determine that overtaking the front vehicle is required when the ego vehicle cannot drive at a set speed due to the front vehicle, and if it is satisfied a predetermined driving situation condition that the ego vehicle does not hinder a traffic flow of surrounding vehicles.

4. The system of claim 3, wherein the lane avoidance determiner comprises a congestion section determiner, a construction section determiner, and a merging section determiner, and
wherein the lane avoidance determiner is configured to determine that avoidance of the driving lane is required when an adjacent lane to the driving lane where the ego vehicle is driving is a congestion section, a construction section, or a merging section.

5. The system of claim 1, wherein the controller comprises a target lane change determiner configured to determine whether changing the target lane of the ego vehicle is required, and
wherein if the strategic lane change determiner determined that the lane change is strategically required and the ego vehicle changed lanes accordingly, the target lane change determiner is configured to change the target lane to the changed lane.

6. The system of claim 5, wherein the controller further comprises a navigation route target lane determiner configured to determine the target lane based on the navigation route, and
wherein the target lane change determiner is configured to change the target lane to an updated route-based target lane when the target lane based on the navigation route has been changed due to an update of the navigation route.

7. The system of claim 5, wherein the target lane change determiner is configured to change the target lane to a current driving lane of the ego vehicle when the ego vehicle is not driving in the target lane, and either the ego vehicle have changed lanes in an opposite direction to the target lane by the driver's input, or a lane change to the target lane has been cancelled by the driver.

8. The system of claim 5, wherein if the strategic lane change determiner determined that the strategic lane change is required and the ego vehicle changed lanes accordingly, and if it is determined that the ego vehicle is driving in a passing lane, the target lane change determiner is configured to change the target lane to a previous driving lane for returning to the previous driving lane.

9. The system of claim 5, wherein the controller comprises a lane recommendation mode determiner configured to determine a recommendation mode from among a route-based lane recommendation mode, a strategic lane recommendation mode, and a driving lane return recommendation mode, based on a driving scenario of the ego vehicle.

10. The system of claim 1, wherein the controller is configured to control the ego vehicle to automatically perform the lane change if a lane change cancellation command from the driver is not received within a predetermined time after providing the lane change recommendation to the driver.

11. A lane change recommendation method, comprising:
performing a route-based lane recommendation based on a target lane according to a navigation route;
determining whether the ego vehicle is driving in the target lane;
when the ego vehicle is driving in the target lane, determining whether a strategic lane change is required; and
if the strategic lane change is required, performing a lane change recommendation to change lanes to an adjacent lane of a driving lane of the ego vehicle.

12. The method of claim 11, further comprising:
when the ego vehicle changed lanes according to the performing of the lane change recommendation, changing the changed lane to a new target lane;
determining whether the ego vehicle is driving in a passing lane after the target lane change; and
if driving in the passing lane, performing a driving lane return recommendation to return to a previous driving lane.

13. The method of claim 11, wherein the determining of whether the strategic lane change is required comprises determining that the strategic lane change is required if it is determined that overtaking a front vehicle is required based on a relationship between the ego vehicle and the front vehicle.

14. The method of claim 11, wherein the determining of whether the strategic lane change is required comprises determining that the strategic lane change is required if it is determined that avoidance of the driving lane is required.

15. The method of claim 14, wherein it is determined that avoidance of the driving lane is required in case that an adjacent lane to the driving lane where the ego vehicle is driving is a congestion section, a construction section, or a merging section.

16. The method of claim 15, wherein if the adjacent lane is a congestion section, a construction section, or a merging section, the performing of the lane change recommendation comprises recommending a lane change to a lane on an opposite side of said adjacent lane.

17. The method of claim 11, wherein if it is determined that the ego vehicle is not driving in the target lane in the determining of whether the ego vehicle is driving in the target lane, if a lane change has been performed in an opposite direction of the target lane by a driver's input or a lane change to the target lane has been cancelled by the driver, the lane where the ego vehicle is currently driving is set as a new target lane.

18. The method of claim 11, further comprising performing a route-based lane recommendation based on an updated route-based target lane if the target lane based on the navigation route has been changed due to an update of the navigation route.

19. The method of claim 11, further comprising controlling the ego vehicle to automatically perform the lane change if a lane change cancellation command from a driver of the ego vehicle is not received within a predetermined time after performing the lane change recommendation.

20. A non-transitory computer-readable recording medium that records a program for executing a lane change recommendation method on a computer, the method comprising:
performing a route-based lane recommendation based on a target lane according to a navigation route;
determining whether the ego vehicle is driving in the target lane;
when the ego vehicle is driving in the target lane, determining whether a strategic lane change is required; and
if the strategic lane change is required, performing a lane change recommendation to change lanes to an adjacent lane of a driving lane of the ego vehicle.
